(19) United States
(12) Patent Application Publication
(10) Pub. No.: US 2007/0284468 A1
(43) Pub. Date: Dec. 13, 2007

(54) Data storage cartridege having separable housing

(75) Inventor: Stephen J. Stamm, Wheat Ridge, CO (US)

Correspondence Address: MORRISON & FOERSTER LLP, 755 PAGE MILL RD, PALO ALTO, CA, 94304-1018, US

(73) Assignee: Quatum Corporation, San Jose, CA (US)

(21) Appl. No.: 11/451,937

(22) Filed: Jun. 12, 2006

(51) Int. Cl. G11B 23/107; G03B 23/02

(52) U.S. Cl. 242/348

(57) ABSTRACT

A data storage cartridge having an expandable or separable housing is described. The storage cartridge includes a reel for supporting storage media wound thereon and a housing enclosing the reel. The reel is disposed between opposing inner surfaces of the housing, the opposing inner surfaces separated by a distance along an axis of rotation of the reel. The housing comprises a separable portion (e.g., a top shell or major surface of the housing) operable to move relative to a portion of the housing and vary the distance between the opposing inner surfaces thereof. The separable portion may be positioned in a closed position, inhibiting rotation of the reel, and an open position, providing clearance for rotation of the reel. The cartridge may include a feature for engaging a portion of a drive and separating when entering the drive.

### BACKGROUND

1. Field

The present invention relates generally to storage devices housing flexible data storage media, and in one example, to a storage device having a separable housing.

2. Related Art

Magnetic tape cartridges have been used to conveniently and efficiently store and handle magnetic recording media for tape drives. One type of tape cartridge consists of a substantially rectangular exterior cartridge housing and a single reel containing a magnetic tape positioned within the housing. The cartridge housing includes an upper housing section and a lower housing section which substantially enclose the magnetic tape, which includes a cartridge leader. The cartridge leader becomes exposed through an opening in the cartridge housing during insertion of the cartridge into the tape drive. The tape drive is then able to engage and retrieve the tape from the cartridge for recording and/or playback.

The reel includes a hub, one or more flanges, and a plurality of teeth that are exposed through an access opening in the lower housing section. A drive clutch on the tape drive engages the teeth in order to rotate the reel. Typically, a spring within the cartridge housing biases the reel toward the lower housing section. During engagement between the drive clutch and the teeth, the tape drive exerts a force against the reel, urging the reel toward the upper housing section, thereby partially compressing the spring to promote a secure engagement between the drive clutch and the reel. The tape drive then rotates the reel and guides the tape across a data transducer that reads data from and/or writes data to the tape.

Increased data storage capacity and retrieval performance is desired of all commercially viable mass storage devices and media, including magnetic tape cartridges. For example, a popular trend is toward multi head, multi-channel fixed or servo (positioning) head structures with narrowed recording gaps and data track widths so that many linear data tracks may be achieved on a tape medium of a predetermined width, such as one-half inch width tape. To increase the storage density for a given cartridge size, the bits on the tape may be written to smaller areas and on a plurality of parallel longitudinal tracks. As more tracks are recorded on the tape, each track becomes increasingly narrow. As the tracks become more narrow, the tape becomes more susceptible to errors caused from the tape shifting up or down (often referred to as lateral tape motion or “LTM”) in a direction perpendicular to the tape travel path as the tape passes by the magnetic head. In order to maintain proper alignment of the head with the data tracks on the tape, the tape is generally mechanically constrained to minimize lateral tape motion and data retrieval errors.

Tape substrates are also being made thinner to increase data storage for a given cartridge size. Thinner tape allows more tape to be contained within the same size diameter reel cartridges, e.g., a standard DLT cartridge of about four inches square and one inch high for use with a five and one quarter inch tape drive. Increasing the tape within a given cartridge increases the data storage capacity of the cartridge. Thinner tapes, however, are generally less rigid making them more susceptible to lateral tape motion errors and damage or wear to the tape; in particular, damage to the tape edges. For example, guides and rollers that may be used, e.g., to define a tape path through a tape drive and reduce lateral tape motion, may cause damage to edge portions of the tape.

Unfortunately, the demand for increased storage capacity for a given size storage device has outpaced the increase storage capacity gained via more narrow data tacks and thinner tape substrates. Accordingly, a storage device having increased data storage capacity for a given cartridge size (such as a conventional form factor) is desired.

### BRIEF SUMMARY

In one aspect and example provided herein a data storage cartridge having separable cartridge housing is described. An exemplary data storage cartridge having a separable cartridge housing may allow for wider storage media to be used within a given size cartridge housing, thereby allowing for increased storage capacity data storage cartridges.

In one example, a data storage cartridge includes a reel for supporting storage media wound thereon, and a cartridge housing enclosing the reel. The reel is disposed between opposing inner surfaces, the opposing inner surfaces separated by a distance along an axis of rotation of the reel, wherein the cartridge housing comprises a separable portion operable to move relative to a portion of the housing and vary the distance between the opposing inner surfaces.

The separable portion may be positioned in a closed position, where the opposing inner surface sandwich or inhibit rotation of the enclosed reel, and an open position, where a desired clearance distance between the opposing inner surfaces is provided for rotation of the reel. The separable portion may include a feature for engaging a drive feature and opening (e.g., causing separation or relative movement of the separable portion from the housing) such that the clearance distance for the reel is increased when inserted into a drive. In one example, the separable portion includes the top shell or top portion of the cartridge housing.

In some examples, the separable portion may be biased in a closed position. Further, the cartridge may include a locking member or assembly for locking the cartridge in a closed position. Additionally, the cartridge may include a holding or limiting member for preventing separation of the separable portion of the housing beyond a predetermined distance.

According to another aspect and example, a media drive for receiving a storage cartridge having a separable portion is provided. In one example, the media drive includes a receiver for receiving a storage cartridge adjacent to a reel driver, wherein the storage cartridge comprises a reel for supporting storage tape thereon enclosed within a housing, the housing comprising a separable portion operable to vary the distance between opposing inner surfaces of the housing along a direction parallel to an axis of rotation of the reel.

The receiver including a feature for engaging the storage cartridge and moving the separable portion of the storage cartridge to increase the distance between the opposing inner surfaces of the housing. The feature for engaging the storage cartridge may do so as the storage cartridge enters the receiver, and may further engages a portion of the separable portion to separate or move the separable portion relative to the housing. The feature may be associated, for example, with a drive rail of the receiver.

According to another aspect and example, a method for driving a data storage tape cartridge is provided. In one example, the method includes receiving a data storage cartridge within a tape drive, wherein the storage cartridge comprises a housing with a reel disposed therein, moving a portion of the housing to increase a clearance distance between an inner surface of the housing and the reel, and streaming a storage tape from the reel of the storage cartridge. The method may further include separating a major surface of the housing to increase the distance between opposing inner surfaces of the housing.

The various aspects and examples of the present invention are better understood upon consideration of the detailed description below in conjunction with the accompanying drawings and claims.

### BRIEF DESCRIPTION OF THE DRAWINGS

FIG. 1 illustrates a plan view of an exemplary magnetic tape drive and magnetic tape cartridge having a separable portion;

FIGS. 2A and 2B illustrate perspective views of an exemplary tape cartridge having separable top and bottom housing portions;

FIGS. 3A and 3B illustrate side cross-sectional views of an exemplary tape cartridge having separable top and bottom housing portions in closed and open/separated positions respectively;

FIG. 3C illustrates a perspective cross-sectional view of the exemplary tape cartridge having separable top and bottom housing portions in an open/separated position;

FIGS. 4A and 4B illustrate an exemplary assembly for aligning and coupling movement of separable housing portions;

FIG. 5 illustrates an exemplary assembly for aligning and coupling movement of separable housing portions;

FIGS. 6A and 6B illustrate an exemplary assembly for aligning and coupling movement of separable housing portions and a locking feature according to one example; and

FIG. 7 illustrate an exemplary buckle retainer feature for use with a tape cartridge having separable top and bottom housing portions.

### DETAILED DESCRIPTION

The following description is presented to enable a person of ordinary skill in the art to make and use the invention. Descriptions of specific materials, techniques, and applications are provided only as examples. Various modifications to the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the scope consistent with the appended claims.

According to one example described herein, an exemplary storage cartridge is provided having a separable (or movable) housing portion. The separable housing portion is generally operable to separate and expand the vertical height of the cartridge (i.e., the height or distance of the cartridge along the direction of the rotational axis of the reel). In particular, a separable portion of the housing is separated or expanded to provide sufficient clearance for rotation of the reel and streaming of tape therefrom. In one example, the cartridge is in a closed position external to a drive and is separated or expanded upon engaging the drive receiver slot (or the like). A cartridge having the ability to separate, e.g., upon insertion to a drive, may allow for wider storage media to be used within a given size cartridge housing, thereby allowing for an increase in storage capacity.

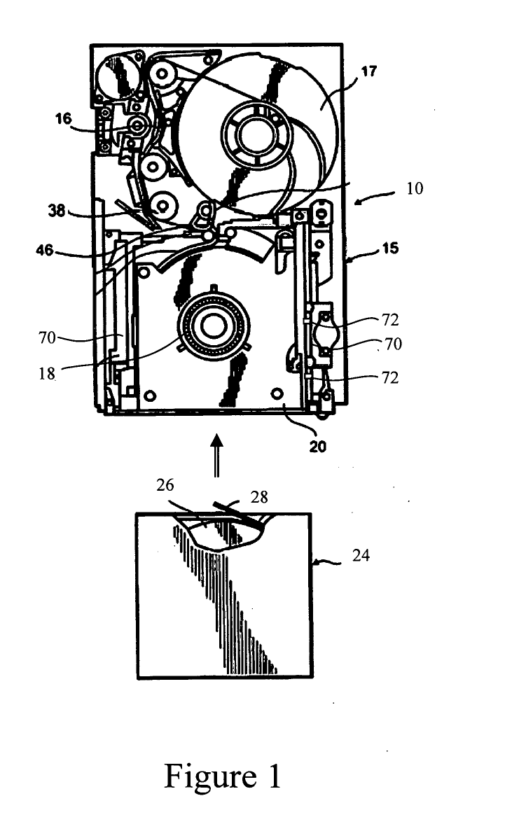

Referring initially to FIG. 1, an exemplary tape drive 10 is illustrated that may be used with an exemplary cartridge 24 having a separable housing portion, and in one particular example, having a top shell portion operable to separate and lift from a bottom shell portion. Tape drive 10 generally includes a tape drive housing 15, a data transducer, i.e., read and/or write head 16, a take-up reel 17, and a receiver slot 20. Tape drive 10 is used in conjunction with a cartridge 24 which houses a storage tape on supply reel 26.

Receiver slot 20 is configured to receive cartridge 24 therein adjacent to reel driver 18. In one example, receiver slot 20 includes one or more guide rails 70 having roller pins 72 (or other feature(s)) for engaging and separating a portion of the housing of cartridge 24 as described in greater detail below. In one example, roller pins 72 (or other portion of guide rails 70 of receiver slot 20) engage and lift or elevate a separable portion, e.g., the top shell, of cartridge 24, thereby allowing reel 26 to rotate with increased clearance. A portion of cartridge 24 may include a suitable feature (not shown in FIG. 1) adapted for engaging roller pins 72, resulting in relative movement of the separable portion of cartridge 24.

Tape drive 10 may also include a door and various mechanisms for receiving and ejecting cartridge 24 as are known in the art. When cartridge 24 is received in receiver slot 20 a buckler motor 46 may engage a cartridge leader 28 and stream storage tape along a tape path, guided by rollers 38, within tape drive 10 passing read/write head 16 and onto take-up reel 17. In other examples, e.g., SDLT drives, there is no separate buckler motor; rather, the buckling motion occurring due to a load motor (not shown) rotating the buckler.

Tape drive 10 is typically installed within or associated with a computer (not shown) or computer network. Additionally, tape drive 10 may be used as part of an automated tape library having a plurality of tape cartridges and a robotic transfer mechanism to transport cartridges to one or more tape drives. An exemplary storage library is described in U.S. Pat. No. 5,760,995, entitled “MULTI-DRIVE, MULTI-MAGAZINE MASS STORAGE AND RETRIEVAL UNIT FOR TAPE CARTRIDGES,” which is hereby incorporated by reference in its entirety.

Cartridge 24 generally includes a substantially rectangular cartridge housing which encloses cartridge reel 26, storage tape (not shown), and a cartridge leader 28. Cartridge 24 may further include a cartridge door to protect storage tape therein and cartridge leader 28, which is exposed when the door is open. Storage tape may include magnetic or optical storage tape that stores information in a form, e.g., digital, that may be subsequently retrieved if desired. Storage tape may be approximately 0.500 to 0.750 inches in width, but larger and smaller widths are contemplated for various sized housings and the like. Storage tape may have a thickness of approximately 0.5 mils (0.0005 inch) or thinner. Typically, storage tape includes a storage surface on one side of storage tape that may be divided into a plurality of parallel tracks along the length of storage tape.

It should be understood that the exemplary cartridges described herein may be used with various media drives not explicitly shown or described. Additionally, various other features of a media drive may be included, for example, various additional or alternative buckler systems, rollers, tape guides, receiving mechanisms, dampers, and the like may be used. A detailed description of various components of a tape drive system that may be used is provided in U.S. Pat. No. 6,095,445, entitled “CARTRIDGE BUCKLER FOR A TAPE DRIVE,” which is incorporated herein by reference in its entirety. Further, a representative magnetic tape drive for which an exemplary storage cartridge may be used is sold by Quantum Corporation under the trademark SDLT™ 320.

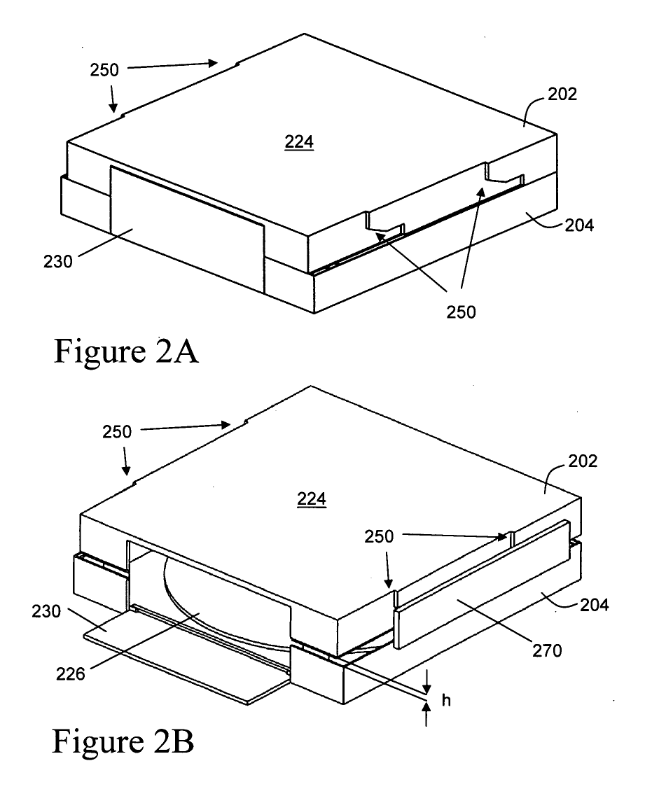

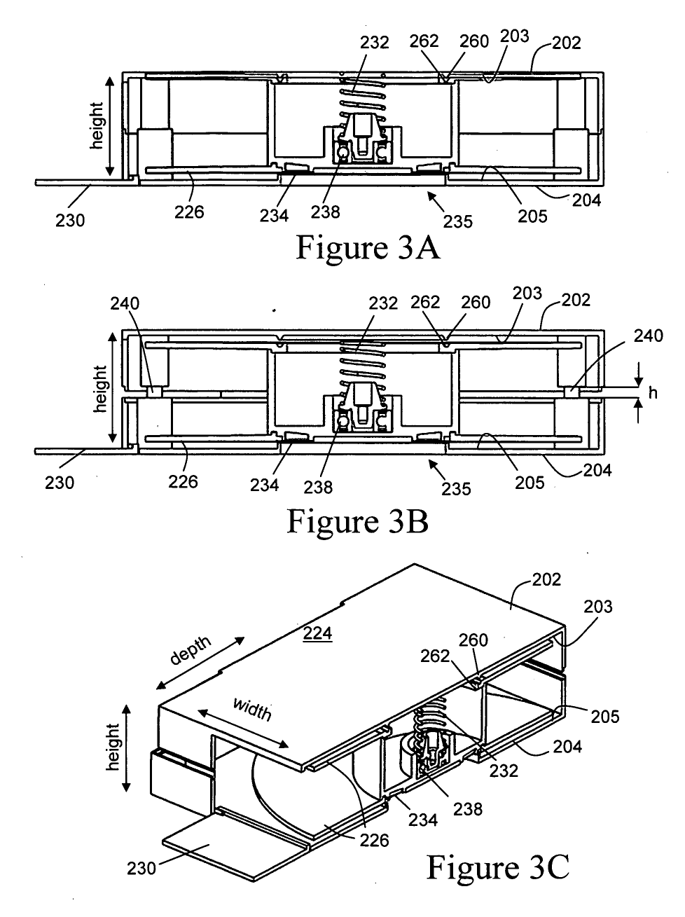

FIGS. 2A and 2B illustrate perspective views of an exemplary tape cartridge 224 having a separable housing portion. Additionally, FIGS. 3A-3C illustrate various cross-sectional views of exemplary tape cartridge 224, and are advantageously reference in combination with FIGS. 2A and 2B.

In this illustrative example, storage cartridge 224 generally includes a housing comprised of two primary sections, a top shell 202 and a lower shell 204. Top shell 202 and bottom shell 204 are coupled in a separable, movable fashion, such that top shell 202 may move relative to bottom shell 204. In particular, top shell 202 may be elevated or lifted relative to bottom shell 204 to increase the clearance distance between inner surfaces 203 and 205 and reel 226 (e.g., the flanges and/or hub of reel 226). Such a feature allows for reel 226 to be housed between opposing inner surfaces 203 and 205 with little or no clearance in a closed position (see, e.g., FIG. 3A), wherein a separable portion, in this example, top shell 202, may separate from bottom shell 204 (see, e.g., FIG. 3B) to provide sufficient clearance for rotation of reel 226 during operation (e.g., when received in a drive).

It is noted that the terms top shell and bottom shell, and the description of the top shell and bottom shell, are used herein for illustrative purposes of one example and ease of description. In other examples, a top shell may be held stationary while a bottom shell moves down, or drops, relative to the top shell. Further, a movable portion may include less than the top half of the housing, and may include, e.g., a major surface (or a portion thereof) that is separable to increase the clearance of the opposing inner surfaces.

Top shell 202 may include a separation feature 250 for engaging a portion of the drive resulting in separation of top shell 202 and bottom shell 205. Separation feature 250 is illustrated in this example as a ramped surface formed in top shell 202, which may engage a portion of the drive (e.g., driver rail 270) to cause top shell 202 to lift relative to bottom shell 204, thereby increasing the distance along the axis of reel 226 between opposing inner surfaces 203 and 205. Roller pins (such as roller pins 72 shown in FIG. 1) of drive rail 270 may engage separation features 250 and elevate or lift a separable portion of the housing (in this example, top shell 202) as cartridge 224 enters a drive receiver. The separation or movement of top shell 202 relative to bottom shell 204 increases the clearance distance between opposing inner surfaces 203 and 205 for reel 226 to rotate, thereby allowing for a wider or larger reel 226 (along the axis of rotation) and wider storage media thereon for a given size housing in the closed position.

Separation feature 250 is shown as a ramped surface in FIG. 1 to illustrate one exemplary feature for engaging a portion of a receiver to cause separation of top shell 202 from bottom shell 204. In other examples, various other features included with top shell 202 or bottom shell 204 may be implemented to cause separation of a separable portion of the housing. For example, various surfaces, pins, roller pins, slots, tabs, and the like may be used. In other examples, a drive may include a mechanical mechanism for engaging top shell 202, bottom shell 204, or both to cause relative movement (whether or not top shell 202 or bottom shell 204 includes a separation feature such as separation feature 250). For example, the drive may include a gripper mechanism (or other mechanical device, magnetic device, or the like) to engage one or both of top shell 202 and bottom shell 204 to cause separation.

As seen more clearly with respect to FIGS. 3A-3C, which illustrate cross-sectional views of cartridge 224, the clearance between opposing surfaces 203 and 205 is increased by separating or moving top shell 202 a distance “h” relative to bottom shell 204. Again, a separable portion, movable to increase the clearance distance between opposing inner surfaces, may include less than top shell 202, e.g., the top major surface of the housing or a portion thereof.

FIG. 3A illustrates cartridge 224 in a “closed” position, generally characterized by having top shell 202 and bottom shell 204 together in a non-separated or closed position. In the closed position, cartridge 224 may have dimensions of a standard form factor cartridge for housing 0.500 inch media; for example, a height (along the axis of rotation of reel 226) of approximately 1.0 inch, depth of 4.15 inch, and width of 4.15 inch. The width of media in these examples, however, may be larger than conventional 0.500 inch width media, e.g., up to about 0.750 inch media for a housing height of approximately 1.0 inch. The increased width of the media is possible because the width of reel 226 may be increased as clearance between reel 226 and inner surfaces 203 and 205 may be reduced or eliminated, and sufficient clearance for rotation of reel 226 provided when the separable portion (e.g., top shell 202) is moved or separated. Of course, the examples provided are applicable to other cartridges of different dimensions and housing different sized media.

In one example, a biasing member 232 is included to bias reel 226, including geared portion 234, toward an opening 235 formed in bottom shell 204. Further, in one example, reel 226 is designed to “float” or translate axially within the housing. In such an instance, a magnet 238 may be included with the hub of reel 226 to provide magnetic coupling with a reel driver (e.g., such as reel driver 18 of FIG. 1).

In one example, reel 226 is sandwiched or locked in place between top shell 202 and bottom shell 204 in the closed position, and reel 226 is unlocked or free to rotate when top shell 202 is separated as illustrated in FIGS. 3B and 3C. Reel 226 may be locked in the closed position by friction between one or both inner surface 203 and 205, or a feature of one or both of the inner surfaces 203 and 205. For example, a rib, boss, or other feature may engage an opposing surface of teeth associated with reel 226 to provide a locking mechanism with top shell 202 and bottom shell 204 together in a closed relationship.

Inner surface 203 of top shell 202 may include an alignment feature 260 for aligning reel 226 and securing reel 226 in a closed position. Alignment feature 260 may include a ridge or protrusion to engage a portion of reel 226, such as a portion of the hub or flange thereof. Reel 226 may include a mating feature 262 (e.g., a slot or indentation) for engaging alignment feature 260 (e.g., a mating ridge) in a closed position. Such an engagement may assist in securing reel 226 in the closed position.

Top shell 202 and bottom shell 204 may further include various protrusions and ribs to sandwich reel 226 there between. Such features may reduce or eliminate movement of reel 226 in a closed position. Additionally, a ring gear of teeth may be incorporated in reel 226 to mate with a ring of teeth in a portion of the housing, e.g., bottom shell 204, to further reduce or eliminate rotation of reel 226 when in a closed position.

In this example, top shell 202 and bottom shell 204 are coupled via one or more extension assemblies 240, which may include mating bosses forming a movable or slidable engagement between top shell 202 and bottom shell 204. In one example, four such extension assemblies 240 are included, generally positioned near each corner of the housing. Further, extension assemblies 240 may be biased in a closed position, e.g., via a spring therein, such that when not within a drive, cartridge 224 is biased or maintained in a closed position. Additionally or alternatively, cartridge 224 may include a locking mechanism for securing top shell 202 and bottom shell 204 in a closed position (see, e.g., FIGS. 6A and 6B). Such features, alone or in combination, may protect the storage media therein from damage or debris resulting from an open housing.

Extension assemblies 240 may be configured to allow for a predetermined separation distance h along a direction parallel to the axis of rotation of reel 226. In other examples, the separation distance h may be determined by the drive when entering the drive receiver. Generally, the separation distance may be determined to allow for a minimum or desired clearance between reel 226 and inner surface 203 of top shell 202 (e.g., 0.050 inches). In one example, in the closed position, reel 226 is separated from inner surface 205 by a suitable clearance distance, e.g., 0.050 inches, and engages inner surface 203 (e.g., no clearance). Accordingly, in the open position, top shell 202 is moved or separated, e.g., 0.050 inches, to provide a similar clearance between reel 226 and inner surface 205 (e.g., 0.050 inches).

In another example, in the closed position, reel 226 is sandwiched between inner surfaces 203 and 205. Top shell 202 separates and moves a distance h along the axis of rotation, the distance h approximately equal to the total of clearances desired above and below reel 226. Additionally, reel 226 moves a distance approximately half of that of top shell 202, e.g., h/2. For example, top shell 202 moves 0.100 inches and reel 226 moves 0.050 inches to create a clearance of 0.050 inches above and below reel 226 and inner surfaces 203 and 205 respectively.

It is noted that reel 226 need not move in concert with top shell 202 and may move, e.g., in response to engaging a reel driver. For example, as cartridge 224 enters a drive receiver a feature may engage top shell 202 and separate it from bottom shell 202 by distance h. Additionally, as a reel driver mates with reel 226, the reel driver may raise reel 226 a distance of approximately h/2 above bottom shell 204, thereby providing a clearance distance of h/2 between the flanges of reel 226 and opposing inner surfaces 203 and 205.

In one example, an exemplary cartridge as described, may achieve relatively greater storage capacities for a given size cartridge. For example, the general size of the cartridge may remain unchanged (in the closed position), with the possible addition of features for engaging a drive receiver and facilitating the separation of the housing portions. Current DLT cartridges, for example, having a height of approximately 1.0 inch (width and depth of about 4.15 inches), include storage media that is 0.500 inches in width. The difference in height of the housing and the storage media is due, for example, to reel 226 (e.g., the thickness of the flanges, etc.), clearances needed for rotation, and the like. A cartridge having a separable housing may allow for the width of the storage media to increase (e.g., to approximately 0.750 inches) with a similar or identical height of the cartridge housing (in the closed, non-separated position shown in FIGS. 2A and 3A).

The increased width allows for an increase in the number of data tracks per longitudinal inch of the storage media (and for a given technology set). Accordingly, increasing the width of the tape by approximately 50 percent may result in a 50 percent increase in storage capacity. Of course, the exact increase in width and storage capacity may vary. Further, many conventional automated tape libraries and tape drives are designed to handle specific cartridge profiles, for example, the DLT Cartridge profile standard. An exemplary separable cartridge may eliminate the need to redesign a library or tape drive to handle a wider storage tape and taller cartridge. Further, the storage capacity for a given size cartridge may be increased without reducing the thickness of the media, which may lead to increased LTM, tape edge damage, and the like.

Exemplary cartridge 224 further includes a door 230 for accessing storage media (not shown) wound on reel 226. In this example, door 230 comprises a flip down door that is hinged to bottom shell 204. As cartridge 224 enters a drive receiver, door 230 may be activated by a protruding boss (not shown) located in the bottom of the receiver (as is generally known in the art).

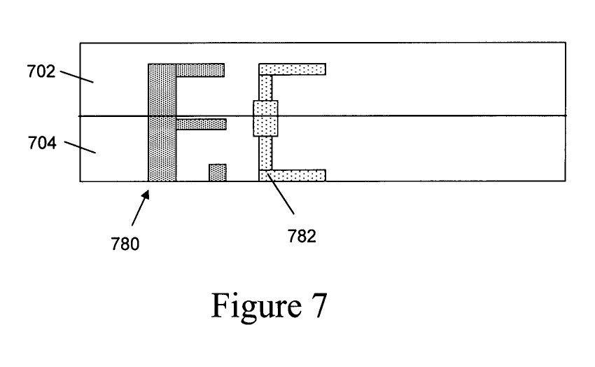

Further, in one example, the cartridge includes an SDLT style buckle retainer feature (see, e.g., FIG. 7); of course, other designs and configurations are possible. The buckle retainer may also be mounted (or co-molded) with bottom shell 204, top shell 202, or combinations thereof.

Cartridge 224 may include various shapes and designs such as square, rectangular, circular, and the like. Cartridge 224 may further include various formed indentations, protrusions, notches, and the like for utility (such as separation upon entering a driver receiver) or aesthetics. It will be recognized by those skilled in the art that numerous configurations and designs for the cartridge housing are possible.

Additionally, the housing of cartridge 224 may include any suitable material. The cartridge housing preferably includes a rigid material to protect the enclosed reel and storage media. Further, the cartridge housing portions may be manufactured by injection molding processes as in the art. Other features such as engagement features 250, door 230, buckle mechanisms, and the like, may be co-molded with the housing or attached thereto in any suitable manner.

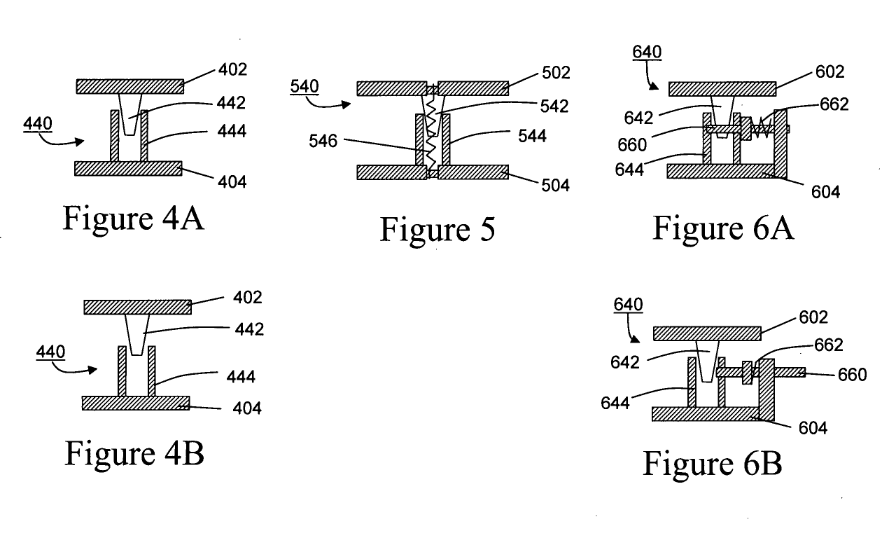

FIGS. 4A and 4B illustrate side cross-sectional views of an extension assembly 440 according to one example. In this particular example, extension assembly 440 includes mating boss elements 442 and 444, where element 442 is attached to top shell 402 and engages or mates with element 444 attached to bottom shell 404. In this instance, element 442 includes a tab or pin that engages a cylindrical element 444 sized for boss element 442. Elements 442 and 444 generally allow for movement along the height of the cartridge housing, e.g., the direction of the axis of rotation of the reel, and restrict or inhibit lateral motion of top shell 402 and bottom shell 402. It will be recognized that various other elements 442 and 444 may be used to couple a separable portion of the housing for movement as described herein.

FIG. 5 illustrates a side cross-sectional view of another exemplary extension assembly 540. This example is similar to extension assembly 440 of FIGS. 4A and 4B, however, extension assembly 540 further includes a holding member 546, which may restrict or prevent top shell 502 and bottom shell 504 from separating completely (or beyond a desired separation distance). In this example, holding member 546 includes a spring or biasing member to bias the assembly (as well as top shell 502 and bottom shell 504) in a closed relationship. In other examples, holding member 546 may include other features, such as interlocking members, fingers, etc., that allow for a limited amount of movement of top shell 502 relative to bottom shell 504.

FIGS. 6A and 6B illustrate side cross-sectional views of another exemplary extension assembly 640. Extension assembly 640 is similar to extension assembly 440 of FIGS. 4A and 4B, however, extension assembly 640 further includes a lock member 660 associated therewith. Lock member 660 operates to selectively lock extension assembly 640 in a closed or open position. For example, lock member 660 may engage boss elements 642, 644, or both to spatially fix them in a given position, e.g., in a closed position.

Lock member 660 may extend through a portion of the housing and be activated manually by a user, e.g., unlocked prior to insertion in a drive. Alternatively or additionally, lock member 660 may engage a portion of the drive or driver receiver to unlock and release top shell 602. Lock member 660 may be biased in an open or closed position; in this instance biased in a locked position via biasing member 662. Upon insertion with a drive, e.g., lock member 660 may be moved to allow for relative movement of top shell 602 and bottom shell 604 as described herein.

FIG. 7 illustrates an exemplary buckle retainer feature 780 for a particular storage format (e.g., for an SDLT style buckling system 782). Appropriate modifications for other style buckling systems will be apparent to those of ordinary skill in the art. Generally, buckle retainer feature 780 may include a separate piece placed in the cartridge over a shell boss. Alternatively, buckle retainer feature 780 may be co-molded with a portion of the housing, e.g., bottom shell 704. In either instance, buckle retainer feature 780 may be mounted to a portion of the housing in a fashion such that the position and operation thereof are not impacted by movement of the separable portion of the cartridge housing, e.g., separation of top shell 702 relative to bottom shell 704. It is noted, however, that depending on the particular implementation, buckle retainer feature 780 may also be included partially or wholly with top shell 702.

Although various aspects of the invention have been described in connection with some specific examples, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. For example, although exemplary cartridges are described herein as comprising a single reel cartridge, a cartridge housing for supporting two or more reels (often referred to a cassette, for example) and having a movable portion as described, is contemplated. The invention is therefore not to be limited by the foregoing illustrative details, but is to be defined according to the claims.

1. A data storage cartridge, comprising:
a reel for supporting storage media wound thereon; and
a cartridge housing for enclosing the reel between opposing inner surfaces, wherein the opposing inner surfaces are separated by a distance along an axis of rotation of the reel, and wherein the cartridge housing comprises a separable portion for varying the distance between the opposing inner surfaces.

2. The data storage cartridge of claim 1, wherein the separable portion is movable along the axis of rotation of the reel and comprises at least a portion of one of the opposing inner surfaces.

3. The data storage cartridge of claim 1, wherein the separable portion is positionable in a first position for inhibiting the reel from rotating and in a second position providing clearance for the reel to rotate.

4. The data storage cartridge of claim 1, wherein the separable portion is coupled to the housing via at least one extension assembly.

5. The data storage cartridge of claim 1, further comprising a lock member for selectively restricting movement of the separable portion.

6. The data storage cartridge of claim 1, further comprising a biasing member for biasing the separable portion in a closed position.

7. The data storage cartridge of claim 1, further comprising a holding member for restricting movement of the separable portion relative to the housing beyond a predetermined distance.

8. The data storage cartridge of claim 1, further comprising a separation feature for engaging a drive receiver and causing the separable portion to move relative to the housing.

9. The data storage cartridge of claim 1, wherein the separable portion comprises a major surface of the cartridge housing.

10. The data storage cartridge of claim 1, wherein the housing comprises a top shell and a bottom shell, the separable portion comprising the top shell of the cartridge housing, and the bottom shell comprising an opening for exposing a hub of the reel.

11. The data storage cartridge of claim 1, wherein the cartridge housing comprises a height of between 0.9 and 1.1 inches, and the reel comprises a storage media wound thereon having a width of greater than 0.5 inches.

12. A media drive for receiving a storage cartridge having a separable portion, the media drive comprising:
a receiver for receiving a storage cartridge adjacent to a reel driver, wherein:
the storage cartridge comprises a reel for supporting storage tape wound thereon within a housing, the housing comprising a separable portion for varying the distance between opposing inner surfaces of the housing along a direction parallel to an axis of rotation of the supply reel, and
the receiver includes a feature for engaging the storage cartridge and moving the separable portion to increase the distance between the opposing inner surfaces of the housing.

13. The media drive of claim 12, wherein the feature engages the storage cartridge as the storage cartridge enters the receiver.

14. The media drive of claim 12, wherein the feature engages a portion of the separable portion for moving the separable portion relative to the drive receiver.

15. The media drive of claim 12, wherein the feature is associated with a drive rail of the receiver.

16. The media drive of claim 12, wherein the feature comprises a roller pin associated with a drive rail of the receiver.

17. The media drive of claim 12, wherein the separable portion comprises a major surface of the storage cartridge.

18. The media drive of claim 12, wherein the separable portion comprises a top shell of the storage cartridge.

19. A method for driving a data storage tape cartridge, comprising:
receiving a data storage cartridge within a tape drive, wherein the data storage cartridge comprises a housing having a reel disposed therein;
moving a portion of the housing to increase a clearance distance between an inner surface of the housing and the reel; and
streaming a storage tape from the reel of the storage cartridge.

20. The method of claim 19, wherein moving a portion of the housing comprises separating a major surface of the housing to increase the distance between opposing inner surfaces of the housing along a direction of the axis of rotation of the reel.

21. The method of claim 19, wherein a feature of the tape drive engages a feature of the cartridge to move the portion of the housing.

22. The method of claim 19, wherein the portion of the housing includes a major surface of the housing.

23. The method of claim 19, wherein the portion of the housing includes a top shell of the housing.
